(19) United States
(12) Patent Application Publication
(10) Pub. No.: US 2024/0015853 A1
(43) Pub. Date: Jan. 11, 2024

(54) Component of an Electric Heating Device and Electric Heating Device

(71) Applicant: Eberspächer catem GmbH & Co. KG, Herxheim (DE)

(72) Inventor: Michael Niederer, Kapellen-Drusweiler (DE)

(21) Appl. No.: 18/218,293

(22) Filed: Jul. 5, 2023

(30) Foreign Application Priority Data
Jul. 7, 2022 (DE) 10 2022 116 921.9

(51) Int. Cl. H05B 3/06; H05B 1/02; H05B 3/04

(52) U.S. Cl. CPC H05B 3/06; H05B 1/0202; H05B 3/04; H05B 2203/02

(57) ABSTRACT

A component of an electric heating device is provided for transferring a waste heat of at least one transistor to a heat carrier (W) surrounding the component. The transistor may be a bipolar transistor with insulated gate electrode (IGBT). The component has a housing of metal, typically aluminum, with an opening for insertion of the transistor in an insertion direction. The housing has, on the inside, at least in sections, opposite walls for the flat, typically indirect, abutment of the transistor.

### BACKGROUND OF THE INVENTION

### 1. Field of the Invention

The present invention relates to a component of an electric heating device, wherein the component is configured to transfer a waste heat of at least one transistor arranged therein to a heat carrier surrounding the component. Furthermore, the present invention relates to an electric heating device comprising a component or said component. “Component” presently is not to be understood restrictively to mean “a part” or “integral”, but rather in the sense of a component or assembly in connection with an electric heating device.

### 2. Background of the Invention

In electric heating devices, in particular with PTC heating elements, a control system with at least one transistor or power transistor or power switch is typically used. The transistor must be cooled to prevent damage to it. If the heat carrier can be used for cooling, this is preferred because the efficiency of the heating devices is increased. However, this is challenging from a structural point of view because transistors are electrical components which must not come into contact with the typically liquid heat carrier, and likewise not with a housing which is typically electrically conductive. In particular, transistors are sensitive and must therefore also be mechanically protected.

For cooling a transistor and partially introducing the waste heat into the heat carrier, DE 10 2016 224 296 A1 proposes cooling the transistor arranged on a busbar on the side of the busbar facing away from the transistor by means of a component configured as a heat sink, wherein the heat sink abuts the busbar in an insulated manner via an electrical insulating layer. In this way, the waste heat of the transistor is conducted via the busbar into the heat sink. In this process, the heat sink extends from the electrical insulating layer via a housing wall into a circulation chamber or heating chamber heated by PTC elements. With the known solution, a portion of the transistor's waste heat is lost into the busbar. In addition, the solution is structurally complex.

### SUMMARY

The problem underlying the present invention is to provide a component for an electric heating device and an electric heating device comprising a component, wherein a waste heat of a transistor can be efficiently dissipated to a heat carrier heatable by the respective electric heating device, and wherein a sufficient mechanical and electrical protection of the transistor is provided.

In order to solve this problem, the present invention specifies a component and/or an electric heating device with such a component.

Accordingly, a component of an electric heating device for transmitting a waste heat of at least one transistor arranged therein to a heat carrier surrounding the component is proposed. The transistor may be a bipolar transistor with insulated gate electrode (IGBT). The component has a housing made of metal, typically aluminum, with an opening for inserting the transistor in an insertion direction. The housing has opposite walls on the inside, at least in sections, for the transistor to abut flatly, typically indirectly. The component may comprise the transistor.

In other words, a component or assembly is proposed comprising a housing made of metal, wherein the housing comprises an opening and walls. In this context, the housing is suitable for use in an electric heating device, namely for transferring a waste heat of one or more transistors, typically IGBT transistors, arranged therein to a heat carrier surrounding the component. In addition, such a transistor or transistors is or are to be insertable into the housing via the opening. The component may already have the transistor. The housing is well suited for mechanical protection.

The component is suitable in connection with bipolar transistors with insulated gate electrode or IGBT transistors. The transistor may be inserted or fitted into the housing such that the housing can abut against the transistor particularly closely, wherein, for example, only a small gap of 1 to 2 millimeters or 1 to 9 tenths of a millimeter remains around the transistor loosely inserted into the housing, for example in order to be able to arrange an insulating pocket around the transistor in the remaining gap. This saves space and makes large areas accessible for heat conduction.

For example, one transistor or two or even more transistors can be inserted, e.g., juxtaposed, into the component or housing in an insertion direction. In this process, the housing can have a substantially and/or regionally constant cross-section, in particular along the insertion direction, i.e., cut transversely to the insertion direction at various points. The opening can be arranged at one end of the component, while on the opposite side a bottom is arranged, wherein the walls are located between the opening and the bottom. If at least one wall is configured to be flat at least in regions and/or from the inside, a transistor can be in good heat-conducting abutment. If two opposite walls are arranged to be flat and/or parallel to each other in regions and/or from the inside, a transistor can be well fixed in the component, e.g., by bonding and/or clamping, e.g. by means of adhesive doped with heat-conducting particles and/or a spring element. The wall or walls may have an at least substantially constant cross-section or constant thickness, at least in regions, for example to allow homogeneous heat conduction. In the case of non-parallel alignment of the opposite wall, for example, a wedge element inserted between one of the walls and the transistor can provide a good heat-conducting planar abutment between the transistor and the walls. In such a configuration, the walls, or at least one of the walls, taper slightly downwards starting from the opening in the insertion direction. Alternatively or additionally, a good heat-conducting adhesive or glue, for example a plastic adhesive filled with good heat-conducting particles, can bridge any distance between the transistor and the walls. Such an adhesive can also fill any remaining spaces between the housing and the transistor to improve heat conduction.

It is also possible that only one wall of the opposite walls is configured to be flat, at least in regions, because a wall which at least indirectly abuts the transistor flatly can be sufficient for heat dissipation. The non-planar wall can, for example, be clamped and/or bonded against the transistor by means of a spring element.

If the component comprises metal, in particular aluminum or copper, or the housing is made of it, particularly good heat conduction between the transistor and the heat carrier can be achieved.

The housing may be thermoformed. Alternatively or additionally, the housing can be impact extruded. This allows the microstructure in the wall to be aligned and/or homogenized. In addition, an increase in strength or a targeted change in strength can be achieved, in particular in the region of the opposing walls. In addition, the fluid tightness of the housing away from the opening is ensured, in particular because the housing can be configured integrally.

If a flange surrounds the opening, the housing cannot only be manufactured particularly easily by means of thermoforming or impact extrusion, but can also be fastened well in an electric heating device. The flange can be fastened, preferably soldered, glued or welded, in a circulation chamber from the inside with the flange abutting a circulation chamber wall. Alternatively, the housing may be inserted through an opening in a circulation chamber or through a circulation chamber wall and thereby protrude into the circulation chamber, wherein the flange may abut the circulation chamber from the outside and be fastened there, preferably soldered, glued or welded. In particular, the flange can be particularly easily fastened and/or sealed to a circulation chamber because the flange can surround the opening and/or span a plane.

The component can have a positioning strip corresponding to the opening. In particular, in this respect, the component is also to be understood as an assembly. The component can therefore also be multi-part. The positioning strip is preferably provided for positioning the transistor and/or the housing or the component and/or a printed circuit board with respect to the transistor. The positioning strip can be insertable and/or inserted or pushed into the opening. The positioning strip can be inserted together with the transistor(s). However, the positioning strip can also be inserted into the opening if the transistor or transistors are already arranged in the housing. The positioning strip may at least substantially close the opening, and thus may also be useful in sealing the housing. The positioning strip may be made of an electrically insulating material, such as plastic.

If a seal frames the opening, the flange and/or the positioning strip and/or closes the opening or housing, the component can be easily mounted. This is because a complex connection between the component and, for example, the circulation chamber, which is both mechanically resistant and fluid-tight, can be dispensed with, because a connection which is only mechanically resistant can suffice, since the seal is provided. For example, the seal may be configured to correspond to the positioning strip and/or the housing, such that the positioning strip is insertable into the seal and into the opening, and such that the positioning strip is insertable into the seal together with the housing.

The positioning strip may have at least one passage for a contact pin of the transistor. The positioning strip can have, in particular, a protruding positioning means, e.g. a pin. typically, several of these are provided in each case. The positioner may be is configured to be tapered at least in sections and/or at the ends. The transistor can be fixed relative to the positioning strip through the passage. By way of the positioner, the positioning described above can be realized. The cone supports the insertion, for example into the housing and/or into the printed circuit board.

In a preferred embodiment, it is provided that the positioning strip has an outside facing away from the opening and an inside facing toward the opening. The outside and the inside are preferably at least substantially parallel. An outer positioning means can be arranged on the outside, which can be used in particular to position or pre-position the transistor with the associated contact pins with respect to a printed circuit board which is to be electrically connected to the transistor. For this purpose, in addition to contact pin receptacles for the contact pins, the printed circuit board may have several positioning bores which are configured to receive the one or more outer positioners, wherein in particular the one or more outer positioners protrude in the insertion direction into the printed circuit board, i.e. protrude further from the positioning strip than the contact pins. Thus, the one or more outer positioners are first inserted into the corresponding positioning bore(s) of the printed circuit board. The insertion movement which then continues inevitably leads to the contact pins being received in the associated contact pin receptacles.

The outer and/or inner positioners can be configured to be tapered at least in sections and/or at the ends. This supports the mounting of the printed circuit board or the insertion into the component or into the opening.

The contact pins may make electrical contact when inserted into the contact pin receptacles or into the printed circuit board. For example, the contact pins can be soldered in or to the contact pin receptacles, but the contact pins do not have to be soldered to the printed circuit board to make electrical contact and can make electrical contact via a plug connection, for example by configuring the contact pin receptacles to clamp the contact pin. If the solder connection is dispensed with, costs can be saved.

An inner positioner can be provided on the inner side. An outer positioner can, in particular, project beyond the positioning strip at the passage piercing contact pins in order to initially cause positioning of the component when the component is inserted together with the positioning strip and the transistor and possibly other parts into a printed circuit board or the like. Several outer positioners may be provided, e.g. two, in order to be able to position in a defined manner.

An outer and an inner positioner can be arranged coaxially and/or at least substantially parallel along the insertion direction. In particular, at least one or the more positioners is or are arranged transversely to the outside and/or inside. This facilitates the manufacturing—in particular the demoldability during injection molding—and improves the stability of the positioners or the positioning strip.

The passage may extend between the outside and the inside. In particular, the passage is square in cross-section and/or adapted to the cross-section of a contact pin of the transistor.

In particular, a plurality of positioners, typically two, are provided. S plurality of inner positioners may be, such that two of the inner positioners can be spaced apart from each other such that the transistor is arranged between the two of the inner positioning means. Instead of or addition to this arrangement, the two of the inner positioners can center the positioning strip in the opening or in the housing, and/or can connect the housing and the positioning strip transversely to the insertion direction in a form-fitting manner. In particular, two inner positioners can abut opposite each other in the opening or be closely arranged against the wall when the positioning strip is inserted in the opening. In this way, the inner positioners ensure that the positioning strip is inserted correctly and cannot cant or tilt in the opening.

An insulating pocket may be provided which insulates the transistor in and with respect to the housing, in particular electrically. The insulating pocket can be made of plastic, ceramic or the like and/or can envelope one or more transistors and electrically insulate them with respect to the housing. The insulating pocket may be arranged in the housing between the transistor and the walls and/or the bottom of the housing. The insulating pocket provides a possibility for the transistor to abut closely against the housing.

If the transistor is pretensioned in a heat-conducting manner on the opposite walls of the housing by at least one spring element and/or is bonded in a heat-conducting manner to the opposite walls or at least one of the walls by way of an adhesive, particularly good and permanent heat transfer from the transistor to the housing is enabled. The spring element can have a spring clip which is arranged, for example, on the outside of the housing with the transistor arranged therein in such a way that the housing or the walls is/are pressed against the transistor, such as under elastic and/or plastic deformation of the housing. The spring element can also have a sheet metal with projecting spring segments and/or sheet metal lugs, wherein the spring segments and/or sheet metal lugs are, for example, cut out or lifted out of the sheet metal at least in sections and/or are bent up to project from the sheet metal. The sheet metal may be arranged between the transistor and the wall or housing, for example also between the insulating pocket and the wall or housing. The transistor may be bonded indirectly or directly in the component or the housing.

For example, for mounting the transistor in the housing, adhesive is filled into the pocket and/or applied to the transistor and/or the insulating pocket and the transistor is inserted into the housing. Curing of the adhesive can take place under, in particular, temporary and housing-deforming pretension of the housing on the transistor, for example by way of a spring element or a pretensioning device, in order to keep the wall(s) in close contact with the transistor. The pretension can be omitted after curing because good heat transfer is then permanently ensured. However, the pretension can also be maintained by way of a spring element to provide redundancy. For improved heat conduction, the adhesive can be doped with, in particular, heat-conducting particles comprising, for example, aluminum oxide and/or silicon dioxide.

The above-mentioned problem is further solved by an electric heating device comprising a circulation chamber with inlet and outlet openings, in particular at a connecting piece, for a heat carrier, at least one PTC heating assembly connected to the circulation chamber in a heat-conducting manner with a PTC heating element for heating the heat carrier in the circulation chamber, and control system comprising at least one transistor for controlling the PTC heating assembly. A component, and typically a plurality of components as described above, contain the at least one transistor at least in sections protrudes into the circulation chamber. The component can also be configured integrally with a partition wall adjacent to the circulation chamber, such as being cast on. In other words, the component may also be integrated to a larger component such as a housing or a housing part. In particular, the transistor is inserted, for example, with an insulating pocket into an opening of a housing of the component and is bonded therein and/or clamped by way of a spring element, wherein a flange may be provided circumferentially at the opening. A positioning strip and/or seal may be arranged at the opening. The aforementioned flange can thereby be part of a partition wall formed by a heating device housing of the electric heating device, which delimits the circulation chamber and/or separates the circulation chamber from the connection chamber. With regard to a compact structure of the electric heating device, the at least one PTC heating assembly may protrude from the same partition wall into the circulation chamber as the component. This partition wall is penetrated not only by the contact pins but also by contact tongues of the respective PTC heating assembly, which are electrically connected in the connection chamber. For this purpose, the connection chamber may have a control system that also includes the aforementioned transistor, which may be electrically connected to the contact tongues via a single printed circuit board provided in the connection chamber. The contact tongues can be electrically plugged in this printed circuit board or in a connection printed circuit board which only serves to group various PTC heating assemblies into heating circuits and which is electrically connected to a further control printed circuit board which essentially realizes the control system. The contact tongues may, but need not, be soldered in the printed circuit board.

The at least one PTC heating assembly, in particular a or the PTC heating element, and the at least one transistor, can be contacted on a common connection plane, for example with a printed circuit board of the control system provided for the at least one transistor and the PTC heating element. In other words, the PTC heating assembly and the transistor are to be positioned at the same height on the connection side so that contact tongues from the PTC heating assemblies and the contact pins of the transistor, for example, can be inserted simultaneously into a regularly planar printed circuit board. This allows a single printed circuit board to be used for contacting the PTC heating assembly(s) and transistor(s), all despite the heat coupling of the transistor(s) into the circulation chamber achieved with the component.

The contact tongues and the contact pins can be contacted via an insertion path, which basically depends on the length of the contact tongues or contact pins. In other words, full electrical contact can be made with the printed circuit board at different heights along the extent of the contact tongues or contact pins. In this process, contact does not have to be made to a stop, for example with respect to the partition wall. The PTC heating assembly(s) and transistor(s) are mostly provided in a non-displaceable or fixed position with respect to the partition wall and can thus be contacted electrically.

The component may be arranged on the side of the circulation chamber essentially in or in the region of a recess in the partition wall. The recess ensures in particular that the component, which is small compared to the PTC heating assembly, can have the heat carrier flowing around it. In particular, the partition wall is configured more thin-walled in the region of a receptacle for the component than in the region of a receptacle for a PTC heating assembly. This is because the electrical contact between the PTC heating assembly and the component should be made at the same level as far as possible, in particular at the connection plane, so that only one printed circuit board can be used, for example.

In the connection chamber, the PTC heating assembly can be electrically contacted or connected via two contact tongues per PTC heating element and the at least one transistor via contact pins. Preferably, the contact pins or the contact tongues protrude through through-openings at least in sections into the connection chamber. The electrical contacting of the contact tongues or the contact pins can be made by mounting and/or soldering the printed circuit board.

The printed circuit board can be provided with female plug element receptacles. The plug element receptacles are, for example, each a metal sheet part to be arranged on the printed circuit board, which can provide electrical contact with strip conductors on the printed circuit board via, for example, two contact arms on a contact tongue or also on a contact pin. The plug element receptacle may be arranged in the region of a contact tongue receptacle or a passage in the printed circuit board in order to contact the contact tongue when it is inserted. An identical or similar structure may be used for contact pins, e.g., to avoid soldering.

The PTC heating assembly can also have thermal expansion compensation regions on the contact tongues, as described in DE 10 2017 221 490 A1, and/or be configured to latch in the region of the partition wall, for example in a receptacle. The PTC heating assembly can also have at least one separating web which leads ahead of the contact tongues and is used for centering when the printed circuit board is mounted. This separating web, which can in particular be tapered at the end, can accordingly be configured in the manner of an outer positioner or act in the manner thereof.

The partition wall can be part of a housing upper part. The housing upper part can form the connection chamber. The housing upper part can have connection passages as accesses to the connection chamber, in particular away from the partition wall. For example, the printed circuit board can be additionally connected to or via the connection passage(s), in particular supplied with power. The connection chamber may be closed by a lid. The lid can seal via a seal, for example in a sealing groove.

The partition wall can have at least one receptacle, in particular with at least one through-opening, for receiving the PTC heating assembly and/or the component. The receptacles, in particular the through-openings, can protrude through the partition wall from the connection chamber to the circulation chamber.

The circulation chamber can essentially be formed by or contained in a housing lower part. The housing lower part may be connectable to a housing upper part or to the housing upper part in the region of the partition wall. In particular, the housing lower part can be securely connected to the housing upper part in a form-fitting manner via connection options or clips. Between the housing upper part and the housing lower part, for example around the partition wall, a seal such as an O-ring can also be arranged in a sealing groove.

The housing upper part may be a die-cast part, e.g. of metal, e.g. of aluminum. The housing lower part may be manufactured via injection molding, e.g. of plastic. The housing upper part and the housing lower part can each be configured in one or more parts and/or comprise or consist of metal and/or plastic. The housing upper part and/or the housing lower part can be manufactured at least partially by die casting, injection molding, machining or milling, 3D printing or combinations thereof. Plastic is inexpensive, can adapt well to thermal expansion, and is suitable for insulation. Metal can shield electromagnetically, conducts heat well, and is heat resistant. Metal can be used to easily shield the control system and/or the PTC heating assembly.

In order to prevent the typically liquid heat carrier from penetrating through the partition wall or the through-opening and/or the receptacle therein into the connection chamber, a seal may be provided at the through-opening and/or the receptacle in each case. The component may be inserted into the partition wall, the through-opening or the receptacle starting from the connection chamber in the direction of the circulation chamber or in the insertion direction. The component may be in circumferential contact with the through-opening in the region of its flange of the housing. Therefore, the component can be circumferentially tightly connected via the flange to the partition wall on the side of the connection chamber, in particular welded on, sealed with a seal and/or glued on.

The PTC heating assembly may be inserted into the receptacle starting from the circulation chamber, wherein the contact tongues can each protrude into the connection chamber through one of the through-openings. The PTC heating assembly may be is sealed in the region of the contact tongues by way of a circumferentially abutting flange or seal. The seal abuts, for example, on the PTC heating element on the one hand and on the through-opening on the other.

The housing lower part may have flow dividers within the circulation chamber, which may be arranged at least substantially parallel to the walls and/or between PTC heating assemblies in the circulation chamber. The flow dividers narrow a gap forming between two PTC heating assemblies, thus causing the heat carrier to flow on average closer to a PTC heating assembly to increase heat dissipation. For example, the flow dividers extend between the partition wall and the bottom of the housing lower part, and in particular substantially parallel to the PTC heating assemblies.

The PTC housings, which are metallic in particular, may abut directly against the housing lower part in sections so as to form a meandering flow path or meandering flow direction.

The opposing walls of the component and/or the PTC housing point essentially parallel to the respective locally present flow direction of the heat carrier in order to generate a flow resistance that is as low as possible. The flow direction can meander within the circulation chamber and split once or several times at the flow dividers.

In the context of the disclosure described above and below, the term “or” stands as a short form for “or rather” and is basically intended to indicate alternative, basically equivalent and/or synonymous features or terms in order to convey the idea or meaning of a feature or term usage in more detail. “Or” can always be replaced with “and/or”.

### BRIEF DESCRIPTION OF THE DRAWINGS

Further details and advantages of the present invention will be apparent from the following description of an embodiment in conjunction with the drawing. Therein:

FIG. 1 shows a component with a housing, two transistors, two insulating pockets, a positioning strip, a seal and a spring element in a first embodiment in a perspective exploded view,

FIG. 2 shows the component of FIG. 1 in a perspective view cut along an insertion direction of the transistor,

FIG. 3 shows a perspective view of the component in FIG. 1 with a printed circuit board suitable for contacting the transistor,

FIG. 4 shows a component in a second embodiment in a perspective exploded view,

FIG. 5 shows the component of FIG. 4 in a perspective view cut along an insertion direction of the transistor,

FIG. 6 shows a perspective view of the component in FIG. 4 with a printed circuit board suitable for contacting the transistor,

FIG. 7 shows an electric heating device with the component of FIG. 4,

FIG. 8 shows a component in a third embodiment in a sectional perspective view, and

FIG. 9A-D shows a heating device with the component in a perspective view from the side of a connection chamber (A), from the side of a circulation chamber (B-C), and a detail of a contacting of contact tongues on a printed circuit board (D).

### DETAILED DESCRIPTION

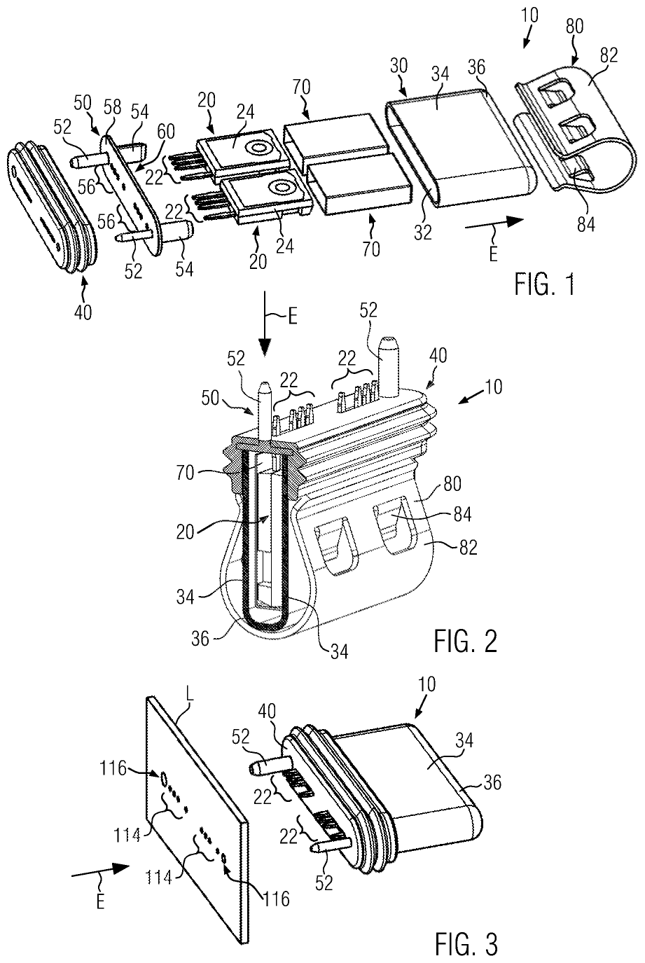

FIG. 1 shows an exploded view of a component 10 of a first embodiment, wherein the individual parts are lined up in principle along an insertion direction E. The component 10 comprises a housing 30 of metal or aluminum with an opening 32 for insertion of the two transistors 20 in the insertion direction E and with two opposite and parallel walls 34. The walls 34 are provided for flat abutment of the transistors 20. The transistors 20 are bipolar transistors with insulated gate electrodes (IGBT). A bottom 36 closing the housing 30 is arranged opposite the opening 32. The opening 32 is configured elongated transversely to the insertion direction E, so that the two transistors can be arranged to be flat juxtaposed in the housing 30 and thereby close to the parallel walls 34. For enveloping and electrically insulating the transistor bodies 24 with respect to the housing 30, two insulating pockets 70 made of plastic, for example a Kapton film, are provided in which the transistor bodies 24 can abut closely so that the transistors 20 arranged in the insulating pockets 70 and in the housing 30 can abut indirectly against the walls 34, and are insulated or electrically insulated in and with respect to the housing 30.

The four contact pins 22 of each transistor 20 of FIG. 1 point along the insertion direction E toward eight corresponding passages 56 on a positioning strip 50. From an inner side 60 of the positioning strip 50, two inner positioners 54 formed as pins point toward the opening to center the positioning strip 50 in the opening. Between the two inner positioners 54, all eight passages 56 are arranged to center the transistors in the opening 32. Coaxially to the inner positioners 54, two outer positioners 52, also formed as a pin, are provided on an outside 58. The outside 58 faces away from the opening 32 and the inside 60 faces the opening 32. The outside 58 and the inside 60 are parallel. The positioning strip 50 is configured as a kind of lid for the opening 32. The passages 56 extend between the outside 58 and the inside 60.

Presently, the two inner positioners 54 are spaced apart from each other such that the transistors 20 are arrangeable or arranged between the two inner positioners 54, in particular juxtaposed and flat, and that the two inner positioners 54 can center or center the positioning strip 50 in the opening 32 or in the housing.

Further, in FIG. 1, a seal 40 is provided to circumferentially seal the housing 30 at the opening 32 or to frame and close the opening 32. In addition, a spring element 80 formed as a spring clip is provided to deform the housing 30 from the outside to the inside to clamp the transistors 20 to be arranged therein against the walls 34. The transistor 20 can be held in a heat-conducting pretensioned manner against the opposing walls 34 via the spring element 80. The spring element 80 is made of a sheet 82 and has inwardly directed spring segments 84 which are lifted out of the plane of the sheet material by punching and bending and abut the housing 30 at several points.

The positioning strip 50 corresponds to the opening 50 and is to be inserted into the opening 32 in FIG. 1 or inserted into the opening 32 in FIGS. 2 and 3. In particular, the positioning strip 50 is configured to be secure against incorrect positioning or insertion of the transistors 20 with the positioning strip 50 into a printed circuit board L and to save space, as follows:

The passages 56 for the contact pins 22 can be irregularly spaced apart—as in the present case—so that the transistors 20 can be inserted into the positioning strip 50 only from the inner side 60 and only in a rotational position of the transistor 20 about the insertion direction E with respect to the positioning strip 50.

The inner positioners 54 can be configured—as also in the present case—as a pin which, along the insertion direction E, has a shape which is only at least essentially circular-segment-shaped in cross-section, the flat side of which can face the opposite pin, and which is tapered or chamfered at its tip, in order to ensure that the inner positioners 54 point towards the opening 32, are arranged close to the transistors 20 in order to save material and space, and can be inserted into the opening 32 without canting.

The outer positioners 52—as is also the case here—can be configured as a pin which has a circular shape in cross-section along the insertion direction E, wherein the positioners 52 opposite the positioning strip 50 have a different cross-section that is clearly visible to the naked eye.

In particular, the housing 30 does not have a flange in the region of the opening 32, for example, in which case—as in the first embodiment—a seal 40 may be provided.

In particular, as in the present case, the housing 30 has an at least substantially constant cross-section along the insertion direction E, so that parallel opposing walls 34 are configured, and so that the housing 30 can be easily manufactured by means of thermoforming and/or impact extrusion. In the present case, the housing 30 is impact extruded. In particular, the walls 34 and/or the housing 30 have an at least substantially constant wall thickness.

Based on the exploded view in FIG. 1, mounting may take place as follows. A first arrangement is created by insulating or enclosing the transistors 20 by the insulating pockets 70, and then or before passing the contact pins 22 through the passages 56.

In order to obtain a second arrangement, the first arrangement is inserted into the opening 32 of the housing 30 in the insertion direction, wherein the inner positioners position the first arrangement in the opening 32 and provide a form fit transverse to the insertion direction E, and typically thereafter or, however, prior thereto, the seal 40 is pushed onto the outside 58 of the positioning strip 50 in the insertion direction E. The seal covers the positioning strip 50 at least approximately completely. The second arrangement may be grouted to provide reliable heat conduction from the transistor to the wall 34 or walls 34.

At the second arrangement, the spring element 80 can be pushed onto the housing 30 or onto the walls from the outside, for example in the insertion direction E or transversely thereto, in order to deform or compress the walls 34 elastically and/or plastically, in particular to press them against the insulating pockets 70 and thus the transistors 20. The resulting assembled component 10 is shown in FIGS. 2 and 3, wherein the spring element 80 is hidden in FIG. 3.

In FIG. 2 it can be seen that the transistor 20 is insulated with respect to the housing 30 by means of the insulating pocket 70 and abuts the housing 30 in a heat-conducting manner. The spring element 80 presses the walls 34 transversely to the insertion direction E against the insulating pocket 70 and thus indirectly against the transistor 20. The component is well suited for transferring a waste heat from the transistors 20 arranged therein to a heat carrier surrounding the component 10 or housing 30 from the outside. The transistors 20 are spaced apart with respect to the outwardly convex bottom 36. Thus, larger transistors 20 can be used in the housing 30.

In particular, in the present case, the housing 30 is configured to be at least partially convex from or outwardly adjacent the opposing walls 34 or on at least one or all of the circumferential narrow sides away from the opening 32—including the bottom 36. This is beneficial to a low flow resistance in a circulation chamber 102.

In particular, it can be seen in FIG. 3 that the outer positioners 52 lead or are configured to lead ahead of the eight contact pins 22 protruding through the passages 56, or protrude further from the positioning strip 50 than the contact pins 22. This ensures that the component 10 is firstly (pre)positioned transversely to the insertion direction E via the two outer positioners 52 initially dipping into the positioning bores 116 when it is inserted into the printed circuit board L, so that the contact pins 22 in the printed circuit board L do not collide or dip into their associated contact pin receptacles 114, for example for electrical contacting, for example by soldering or by unsoldered abutment or a plug connector, without collision—later than the positioners 52 in their positioning bores 116. In this process, the component 10 of FIG. 3 can be inserted into a wall of a circulation chamber 102 along the insertion direction E from the inside of the circulation chamber 102 so that the contact pins 22 and the positioners 52 become accessible to the printed circuit board L from the outside of the circulation chamber 102 and the housing 30 protrudes into the circulation chamber 102 in sections. However, the component 10 can also be inserted, with or without the printed circuit board L, from the outside into a wall of a circulation chamber 102, so that the component 10 protrudes into the circulation chamber 102 in sections, in particular with the housing 30. In all cases, the seal 40 may provide a circumferential seal of the housing relative to the circulation chamber 102 at the opening 32, so that the transistor does not come into contact with a heat carrier W from the circulation chamber 102.

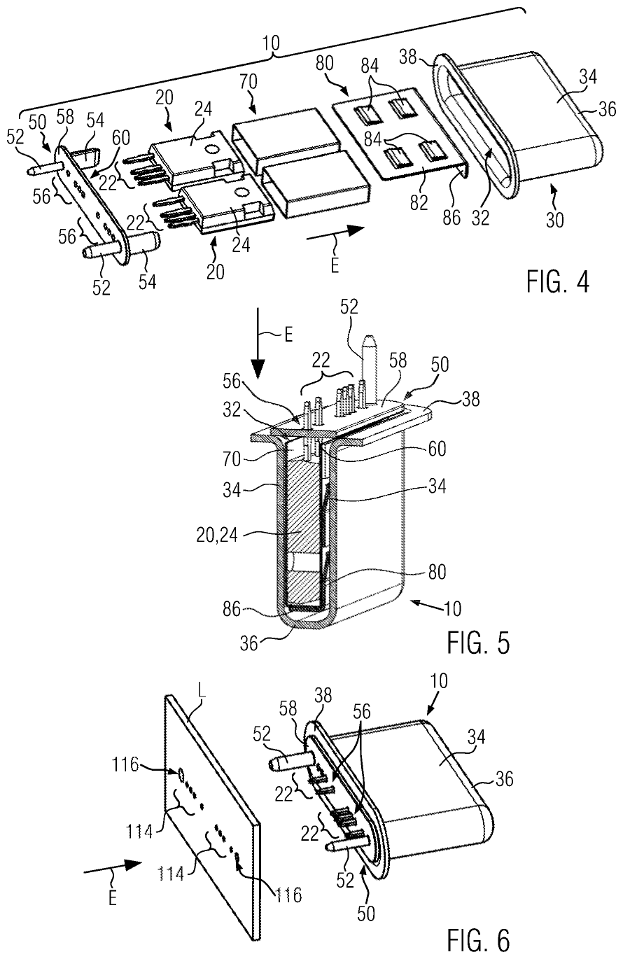

FIGS. 4, 5 and 6 show a second embodiment of a component 10. In FIG. 4, an exploded view is shown, which is to be understood analogously to that of FIG. 1. Consequently, the features described above apply accordingly; in particular, however, the second embodiment differs from the first embodiment in that and/or distinguishes the second embodiment in that:
the housing 30 is impact extruded,
the housing 30 has a flange 38 at the opening, which surrounds the opening 32 and projects transversely to the insertion direction E and thus spans a plane,
no seal 40 is provided, and/or
in particular instead of a spring element 80 acting from the outside on the housing and configured as a spring clip, a spring element 80 configured as a sheet 82 with spring segments 84 projecting from the sheet 82 is provided, wherein the present spring element 80 can clamp or clamps itself from the inside between insulating pocket 70 and one of the walls 34, so that the transistors 20 abut flatly against only one of the walls 34.

The spring element 80 may alternatively or additionally comprise a protrusion 86 for engaging behind the transistors 20, so that the spring element 80 remains in position during insertion.

The flange 38 of the component 10 or housing 30 is provided for welding, particularly in the region of a circulation chamber 102. In particular, the flange 38 is to be welded when no transistor 20 is arranged in the housing 30 to prevent damage to the transistor 20 from welding. The housing 30 may abut against a circulation chamber wall from the inside in the insertion direction E or against a circulation chamber wall from the outside to be welded just there. Instead of welding, soldering or gluing is also conceivable.

Based on the exploded view in FIG. 4, mounting may take place as follows. A first arrangement is created by insulating or enclosing the transistors 20 by the insulating pockets 70, and then or before passing the contact pins 22 through the passages 56. In addition, at any given time, the sheet metal spring element 80 may be placed on the insulating pockets 70 or already inserted into the housing 30.

In order to obtain a second arrangement, the first arrangement, typically with the spring element which can engage behind the transistors 20 by means of protrusion 86, is inserted into the opening 32 of the housing 30 in the insertion direction, wherein the inner positioners position the first arrangement in the opening 32 and provide a form fit transverse to the insertion direction E. The second arrangement may be grouted to provide secure heat conduction from the transistor to the wall or walls 34.

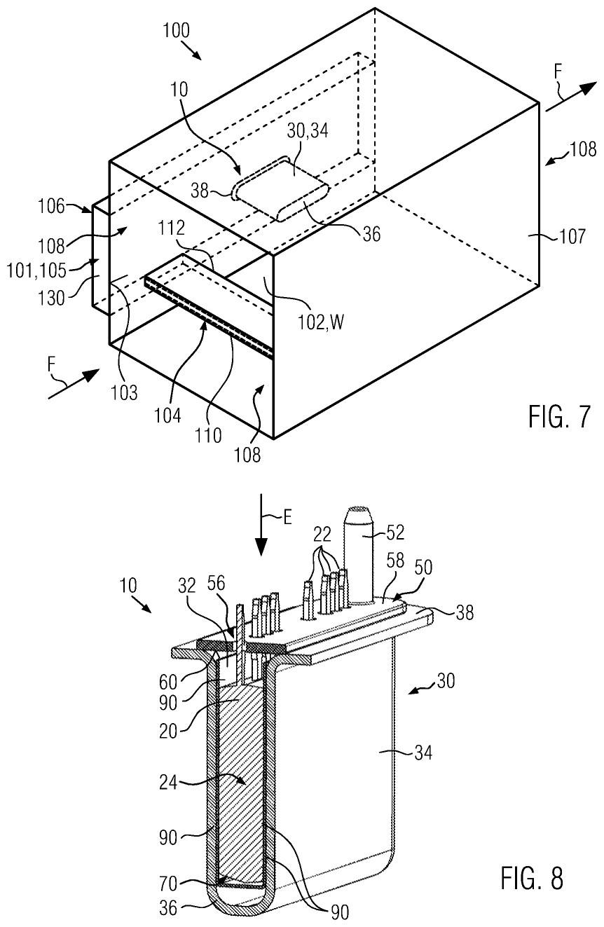

FIG. 7 shows an electric heating device 100 having a circulation chamber 102 with inlet and outlet openings 108 for a heat carrier W flowing therein from the inlet opening 108 to the outlet opening 108 in the flow direction F, a PTC heating assembly 104 connected to the circulation chamber 102 in a heat-conducting manner for heating the heat carrier W in the circulation chamber 102, and a control system 106 (partly shown in dashed lines) comprising two transistors 20 and arranged in a connection chamber 101 for controlling the PTC heating assembly 104 (partly shown in dashed lines). The connection chamber 101 is separated from the circulation chamber 102 by a fluid-tight partition wall 103.

In the present case, the connection chamber 101 is closed by a lid 144.

The connection chamber 101 is arranged in a housing upper part 130, while the circulation chamber 102 is contained in a housing lower part 107 attached to the housing upper part 130 in the region of the partition wall 103.

A component 10 containing the transistors 20 at least in sections, and specifically the component 10 of FIGS. 4 to 6, protrudes from the partition wall 103 into the circulation chamber 102. The transistors 20 are arranged at least indirectly within the circulation chamber 102. In this process, the component 10 is welded to the inside of the circulation chamber 102 or the partition wall 103 via a flange 38, so that the contact pins 22 of the transistors 20 are led out of the circulation chamber 102 and can be contacted by the control system 106 arranged outside the circulation chamber, for example via the printed circuit board L contained therein.

The parallel, opposing walls 34 of the component point substantially parallel to the direction of flow F of the heat carrier W to create as little flow resistance as possible. In the circulation chamber 102, otherwise substantially convex surfaces or narrow sides project from between the walls 34 of the housing 30 at the component 10, which are therefore favorably configured in terms of flow.

The PTC heating assembly 104, which also protrudes from the partition wall 103 into the circulation chamber 102, has a PTC heating element 110 on the inside (shown dashed) and a PTC housing 112 on the outside, which is connected to the PTC heating element 110 in a heat-conducting manner and fluidically separates the PTC heating element 110 from the heat carrier W or the circulation chamber 102. The heat carrier W flowing around the PTC housing 112 and thus the PTC heating assembly 104 can thus be heated by the PTC heating element 110. To operate the PTC heating assembly 104, the two transistors 20 are electrically operated, wherein they generate waste heat which can be efficiently transferred to the heat carrier W thanks to the proposed arrangement.

The heat carrier W can be present in gaseous and/or liquid form. For example, it can be water, water vapor, air and/or other substances.

In the bonded variant of a component 10 shown in FIG. 8, a particle-doped adhesive is provided as the adhesive 90. A spring element 80 has been dispensed with. Relative to the thickness of the insulating pocket 70, the adhesive 90 is at least an order of magnitude thinner and therefore almost invisible to the naked eye because it merely forms a thin skin on the insulating pocket 70 or in the housing 30 or on the transistor body 24. In this respect, the adhesive is arranged between transistor body 24 and insulating pocket 70 and between insulating pocket 70 and housing 30 or walls 34. However, the adhesive 90 can also be dispensed with, in particular in the region between the insulating pocket 70 and the transistor body 24, because the insulating pocket 70, which is made of plastic, can already be in contact with the transistor body 24 in a force-fitting manner.

The particles of the adhesive 90 may comprise or consist of silicon dioxide and/or aluminum dioxide. However, metallic particles such as aluminum, copper, silver or the like are also conceivable in principle, insofar as the insulation of the transistor 20 with respect to the housing 30 is ensured, for example by means of the insulating pocket 70. In the present case, the adhesive 90 is provided with aluminum dioxide particles which have a higher thermal conductivity than the other components of the adhesive 90.

When a spring element 80 is used, a fluid, electrically non-conductive heat transfer medium may also be introduced into the housing 30, for example, an oil or the adhesive 90. In this way, the heat transfer from a transistor 20 to a wall 34 may be improved.

The component 10 or housing 30 was pressed together during curing of the adhesive 90 with deformation of the walls 34 in the direction of the transistors 20 and released after curing. In this case, it is preferred to have a spring element 80 acting on the housing from the outside and to remove the spring element 80 after the adhesive 90 has cured or to leave it arranged thereon for increased security.

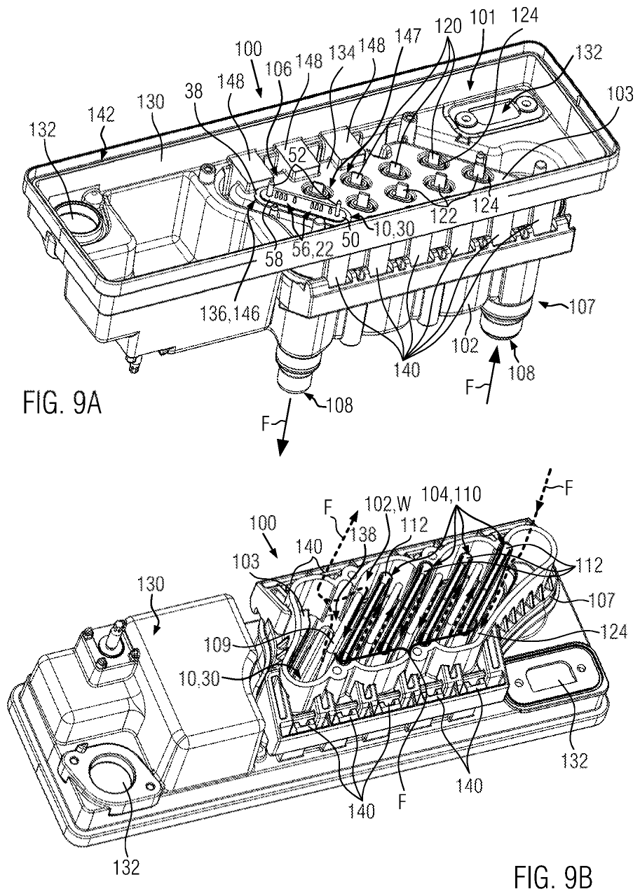

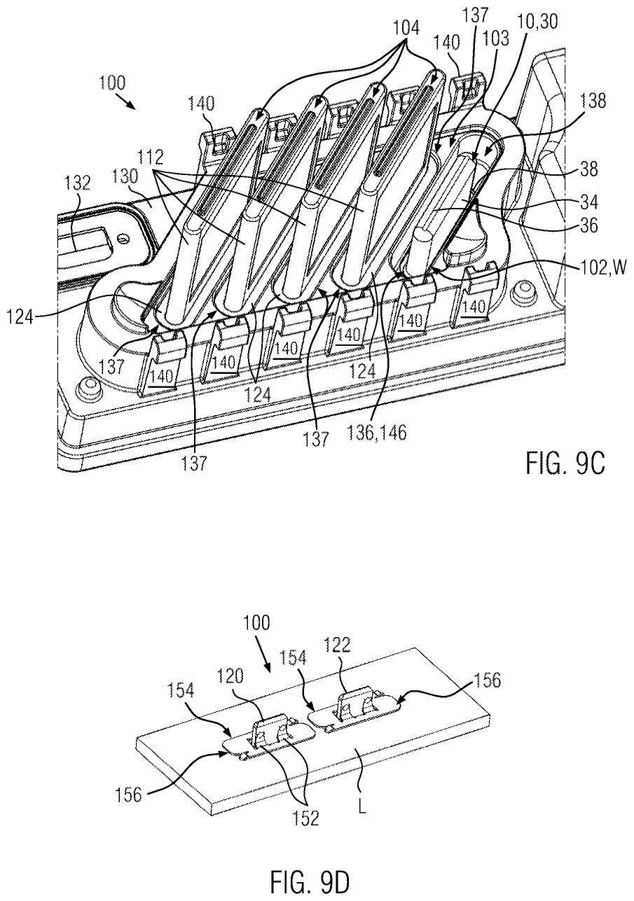

With reference to FIGS. 9A-D, another embodiment of an electric heating device 100 is described below for introducing waste heat from transistors 20 into a heat carrier W heated by PTC heating assemblies 104. Here, a component 10 or housing 30 such as that of FIGS. 4 to 6 is used. Another component 10 such as that of FIGS. 1 to 3 or FIG. 8 is also conceivable.

The electric heating device 100 comprises: a circulation chamber 102 with inlet and outlet openings 108 at a respective connecting piece of a housing lower part 107 for the heat carrier W flowing therein from the inlet opening 108 to the outlet opening 108 in the flow direction F; four PTC heating assemblies 104 provided in the circulation chamber 102 for heating the heat carrier Win the circulation chamber 102; and a control system 106 comprising two transistors 20 and a printed circuit board L with strip conductors and arranged substantially in a connection chamber 101 for controlling the PTC heating assemblies 104. The transistors 20 are arranged in an aluminum component 10 connected to the circulation chamber 102 in a heat-conducting manner, more specifically in its housing 30. The component 10 corresponds to that of FIGS. 4 to 6.

The connection chamber 101 is separated from the circulation chamber 102 by a partition wall 103. The connection chamber 101 may be closed by a lid 144 as shown in FIG. 7. The lid 144 may seal via a seal in the sealing groove 142.

The partition wall 103 is part of a housing upper part 130. The housing upper part 130 also forms the connection chamber 101. In the present case, the partition wall 103 has five receptacles 136, 137 with through-openings 146, 147. The receptacle 136 is provided for receiving the component 10 and comprises the through-opening 146. The receptacles 137 are provided to receive the PTC heating assemblies 104 and each have two through-openings 147. The receptacles 136, 137 with the through-openings 146, 147 protrude through the partition wall 103 from the connection chamber 101 to the circulation chamber 102.

Furthermore, two connection passages 132 are provided away from the partition wall 103 as accesses to the connection chamber 101 or for connection of the control system 106 via connectors, for example on the printed circuit board L hidden in FIG. 9A-C.

In the connection chamber 101, the PTC heating assemblies 104, each comprising a PTC heating element 110, can be electrically contacted or connected via two contact tongues 120, 122 per PTC heating element 110, and the two transistors 20 can be electrically contacted or connected via four contact pins 22w. The contact pins 22 and the contact tongues 120 protrude through the through-openings 146, 147 at least in sections into the connection chamber 101, while the transistor bodies 24 and PTC heating elements 110 are arranged at least in sections and indirectly in the circulation chamber 102.

Electrical contacting of the transistors 20 and of the PTC heating assemblies 104 can be realized on a common connection plane 134 on the side of the partition wall 103 facing away from the circulation chamber 102, allowing a single printed circuit board L to be used for electrical contact. The printed circuit board L is also connectable to or via the connection passage(s) 132 to provide electrical power.

The electrical contacting of the contact tongues 120, 122 or the contact pins 22 can be made by mounting the printed circuit board L. Soldering is not necessary in the present case.

FIG. 9D shows the printed circuit board L, which is provided with two female plug element receptacles 156. The plug element receptacles 156 are each a metallic sheet metal part arranged on the printed circuit board L, which can provide electrical contact with strip conductors on the printed circuit board L via two contact arms 152 on a contact tongue 120, 122 or also on a contact pin 22. The plug element receptacle 156 is arranged in the region of a contact tongue receptacle 154, that is, a passage for a contact tongue 120, 122, in the printed circuit board L to contact the contact tongue 120, 122 when it is inserted. A similar structure is used for the contact pins 22. The contact tongues 120, 122 and the contact pins 22 can be contacted via an insertion path that depends on the length of the contact tongues 120, 122 and contact pins 22, respectively.

The circulation chamber 102 is essentially formed by or contained in the housing lower part 107, which is connectable to the housing upper part 130 in the region of the partition wall 103. The housing lower part 107 can be securely connected to the housing upper part 130 in a form-fitting manner via connection options 140 configured as clips.

The housing upper part 130 is a metallic die-cast aluminum part. Therefore, the control system 106 and the PTC heating assemblies 104 can be electromagnetically shielded. The housing lower part 107 is made of plastic by means of injection molding.

The component 10 containing the transistors 20 and each of their transistor bodies 24 protrudes from the partition wall 103 into the circulation chamber 102. The transistors 20 are arranged at least indirectly in the circulation chamber 102.

In order to prevent the heat carrier W from penetrating through the partition wall 103 or the through-openings 146, 147 into the connection chamber 101, a seal is provided at each of the through-openings 146, 147.

Starting from the connection chamber 101, the component 10 is inserted into the partition wall 103 or the through-opening 146 or the receptacle 136 in the direction of the circulation chamber 102 or in the insertion direction E. In the process, the component 10 abuts circumferentially against the through-opening 146 in the region of its flange 38 of the housing 30. Therefore, the component 10 is circumferentially tightly connected, presently welded, to the partition wall 103 on the side of the connection chamber 101 via the flange 38.

The component 10 is arranged on the side of the circulation chamber 102 substantially in or in the region of a recess 138 of the partition wall 103. The partition wall 103 is configured more thin-walled in the region of the receptacle 136 for the component 10 than in the region of a receptacle 137 for a PTC heating assembly 104. This is because the electrical contact between the PTC heating assembly 104 and the component 10 should be made at the same height as far as possible, presently at the connection plane 134, in order to be able to use only one printed circuit board L. The recess 138 ensures that the heat transfer medium W reaches the component 10.

As shown in FIG. 9A, three contact surfaces 148 are arranged in the region of the partition wall 103. The contact surfaces 148 are connected to the circulation chamber 102 via the partition wall 103 in a heat-conducting manner. The contact surfaces 148 are configured here as protrusions relative to the partition wall 103. Electrical components, such as further transistors 20 or control components, may be secured to the contact surfaces 148 in a heat-conducting manner to allow heat to be transferred to the heat carrier W via the circulation chamber 102.

Not shown is that contact surfaces 148 may be omitted, for example, if all necessary transistors 20 are already arranged in a component 10.

The PTC heating assemblies 104 are inserted into the receptacles 137 starting from the circulation chamber 102, wherein the contact tongues 120, 122 then each protrude into the connection chamber 101 through one of the through-openings 147. The PTC heating assemblies 104 are sealed in the region of the contact tongues 120, 122 by a circumferentially abutting seal 124. The seal 124 abuts the PTC heating elements 110 on the one hand and the respective insertion opening 146 on the other.

As shown in the sectional view of the circulation chamber 102 in FIG. 9B, the housing lower part 107 comprises flow dividers 109 within the circulation chamber 102, which are arranged parallel to the walls 34 and between the PTC heating assemblies 104 in the circulation chamber 102. The flow dividers 109 narrow a gap forming between two PTC heating assemblies 104. Here, the flow dividers 109 extend between the partition wall 103 and the bottom of the housing lower part 107, which is cut off in this view, and parallel to the PTC heating assemblies 104.

FIG. 9B shows that the parallel, opposing walls 34 of the component 10 point substantially parallel to the respective flow direction F of the heat carrier W. The metallic PTC housings 112 abut directly against the housing lower part 107 in sections, thus guiding the flow direction F. The flow direction F meanders starting from the inlet opening 108 at the connecting piece inside the circulation chamber 102 and branches three times between each two PTC heating assemblies 104 and once between a PTC heating assembly 104 and the component 10 each at one of the four flow dividers 109 and ends up in the outlet opening 108 at the other connecting piece.

Along the flow direction F, the component 10 is arranged last-order with respect to the PTC heating assemblies 104, as a result of which the component 10 will experience the highest temperature of the heat carrier W. In a conceivable reversal of the flow direction F, the component 10 is flowed around by the heat carrier W at its probably lowest temperature.

The heat carrier W flowing around the PTC housing 112 and thus the PTC heating assembly 104 can be heated by each of the four PTC heating elements 110. To operate the PTC heating assembly 104, the two transistors 20 are electrically operated, wherein the transistors 20 generate waste heat that can be efficiently dissipated to the heat carrier W thanks to the proposed arrangement.

The above-described FIGS. 9A-C show an inserted component 10. The component 10 can also be manufactured integrally or monolithically with the housing upper part 130, e.g. by means of die casting. The arrangement or representation in FIGS. 9A-C is then unchanged.

1. A component of an electric heating device for transferring a waste heat of at least one transistor arranged therein to a heat carrier (W) surrounding the component, the component comprising: an aluminum housing with an opening for insertion of the transistor in an insertion direction, wherein the housing has, on an inside thereof, at least in sections, opposite walls for the flat, indirect, abutment of the transistor.

2. The component according to claim 1, wherein the housing is thermoformed or impact extruded.

3. The component according to claim 1, further comprising a flange surrounding the opening.

4. The component according to claim 1, further comprising a positioning strip inserted into the opening.

5. The component according to claim 4, further comprising a seal framing the opening and/or the positioning strip and/or closing the opening.

6. The component according to claim 4, wherein the positioning strip has a passage for a contact pin of the transistor, and/or a positioner.

7. The component according to claim 4, wherein the positioning strip has an outside facing away from the opening and/or an inside facing the opening, wherein 1) an outer positioner is provided on the outside, and/or 2) an inner positioner is provided on the inside, and/or 3) the passage extends between the outside and the inside.

8. The component according to claim 7, further comprising first and second inner positioners that are spaced apart such that the transistor can be arranged therebetween, and/or such that the inner positioners center the positioning strip in the opening or in the housing, respectively.

9. The component according to claim 1, further comprising an insulating pocket that is configured to insulate the transistor in and with respect to the housing.

10. The component according to claim 1, wherein the housing is configured to hold the transistor under pretension in a heat-conducting manner on the opposite walls of the housing by at least one spring element.

11. The component according to claim 1, wherein the opposite walls or at least one of the walls of the housing are configured to bonded to the transistor via an adhesive that is doped with particles.

12. The component according to claim 1, wherein the transistor is a bipolar transistor with an insulated gate electrode (IGBT).

13. An electric heating device, comprising:
a circulation chamber with inlet and outlet openings for a heat carrier (W);
at least one PTC heating assembly connected to the circulation chamber in a heat-conducting manner, the PTC heating assembly including a PTC heating element for heating the heat carrier (W) in the circulation chamber;
a control system comprising at least one transistor for controlling the PTC heating assembly, the control system including at least one transistor; and
at least one component containing the at least one transistor, at least in section, wherein the component protrudes into the circulation chamber and includes an aluminum housing with an opening for insertion of the transistor in an insertion in an insertion direction, wherein the housing has, on an inside thereof, at least in sections, opposite walls for the flat, indirect, abutment of the transistor.

14. The electric heating device according to claim 13, wherein the PTC heating element and the at least one transistor are contactable on a common connection plane.

15. The electric heating device according to claim 14, wherein the PTC heating element and the at least one transistor are contactable with a printed circuit board of the control system that is provided for the at least one transistor and the PTC heating element.
